(19) United States
(12) Patent Application Publication
(10) Pub. No.: US 2007/0279936 A1
(43) Pub. Date: Dec. 6, 2007

(54) Backlight unit and liquid crystal display

(76) Inventors: Chun-Ho Song, Seoul (KR); Byung-Choon Yang, Seongnami-si (KR); Gi-Cherl Kim, Yongin-si (KR); Sang-Yu Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/442,948

(22) Filed: May 30, 2006

(30) Foreign Application Priority Data
May 30, 2006 (KR) 10-2005-0045503

(51) Int. Cl. F21V 7/04

(52) U.S. Cl. 362/613

(57) ABSTRACT

A backlight unit includes light sources and optical mixers individually formed between the light sources to reflect light. The light emitted from the light sources becomes uniform while passing the optical mixers. Even when the thickness of the backlight unit is thinner, the brightness distribution of the light becomes uniform.

This application claims priority to Korean Patent Application No. 2005-0045503, filed on May 30, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a backlight unit.

(b) Description of the Related Art

Flat panel displays have been the choice of electronics consumers as they have enhanced capacity with a small size and a light weight, based on the semiconductor technology that has rapidly developed in recent times.

Among the flat panel displays, a liquid crystal display (“LCD”) with advantages of small size, light weight, and lower power consumption has been spotlighted as an alternative that is capable of overcoming the disadvantages of the conventional cathode ray tube (“CRT”) and replacing the CRT. The LCD is presently used in almost all information processing appliances requiring a display device.

The LCD include an upper panel with a common electrode and color filters, a lower panel with thin film transistors and pixel electrodes, and a liquid crystal material injected between the two panels. Different potentials are applied to the pixel and common electrodes to form electric fields, and liquid crystal molecules in the liquid crystal material are rearranged due to the electric fields, thereby controlling light transmittance and displaying desired images.

The liquid crystal panel of the LCD is a light-receiving element that does not emit light by itself, and hence a backlight unit is provided at the bottom of the liquid crystal panel to illuminate light to the liquid crystal panel. The backlight unit includes a lamp, a light guide plate, a reflective sheet, and an optical sheet. The lamp is formed with a cold CRT type of lamp that discharges a relatively small amount of heat, generates a white light approximating natural light, and has a long life span, or an LED type of lamp that uses light emitting diodes (LEDs) with excellent color representation and lower power consumption. Although the cold CRT type of lamp has been conventionally used, the LED type of lamp has begun to replace for the CRT type of lamp as it has advantages of excellent color representation and lower power consumption.

With the LED-typed lamp, red, green, and blue LEDs may be provided and associated together to illuminate a white light to the liquid crystal panel based on the sum of the three colors, or the LED may illuminate the white light by itself. The backlight units are classified into an edge type and a direct type depending upon the locations of the LED-typed lamp for illuminating the light to the liquid crystal panel. With the edge type, the LED is located at a lateral side of the liquid crystal panel to illuminate the light from the lateral side, and with the direct type, the LED is located at the rear side of the liquid crystal panel to illuminate the light therefrom.

With the edge type, as the light is illuminated to only one lateral side of the panel, the light is increasingly concentrated on that area with the enlargement of the panel. As the liquid crystal panels are tending to become larger, the direct type is preferred rather than the edge type, so development is being actively pursued for the direct-type backlight units.

The light from the LED travels straight and concentrates on the front side of the LED. Accordingly, the light is not uniformly diffused to the entire area of the liquid crystal panel. The front side of the LED is relatively bright, and the panel becomes darker toward the rear side thereof so that bright lines are generated over the entire area of the panel.

In order to reduce the bright lines, the thickness of the direct-type backlight unit should exceed a predetermined value. That is, bright lines are perceived due to regional brightness differences with the backlight unit having a thickness smaller than the predetermined value, so it is difficult to reduce the size of the backlight to a reasonably thin thickness.

### BRIEF SUMMARY OF THE INVENTION

An exemplary embodiment of the present invention provides a backlight unit that is thin and has a uniform brightness distribution.

According to an another embodiment of the present invention, a backlight unit including light sources is provided, in which optical mixers are individually formed between the light sources.

The optical mixers may be formed with a reflective material, they may be shaped as cones, and their height may be greater than the height of the light sources.

The light sources may be aligned with each other in columns and rows, and the optical mixers may be formed between the light sources neighboring each other along the columns or the rows, or in a diagonal direction. The optical mixers may be spaced apart from the light sources neighboring the optical mixers by the same distance.

The light sources may be arranged along a row such that they are spaced apart from each other by a predetermined distance, and the light sources at one row may diverge in arrangement from the light sources at an adjacent row.

The optical mixers may be formed between neighboring light sources, and they may be placed between the light sources formed along a row and spaced apart from two light sources neighboring the optical mixer along the row by the same distance.

A diffusion plate may be formed over the light sources and the optical mixers, and a plurality of optical sheets may be formed over the diffusion plate. The bottom surface of the diffusion plate may be spaced apart from the top surface of the optical mixers by a predetermined distance, and a reflective sheet may be formed under the light sources and the optical mixers.

According to another embodiment of the present invention, a liquid crystal display includes a display panel, and a backlight unit placed under the display panel with light sources and optical mixers. The optical mixers are individually formed between the light sources, and the light sources emit light toward the display panel.

The optical mixers may have a height greater than the height of the light sources, they may be aligned with each other in columns and rows, and they may be formed between neighboring light sources. The optical mixers may be formed along the columns or the rows, or they may be formed between the neighboring light sources in the diagonal direction.

The optical mixers may be spaced apart from the light sources neighboring the optical mixer by the same distance, and the light sources may be arranged along a row such that they are spaced apart from each other by a predetermined distance and diverged in arrangement from the light sources at an adjacent row.

The optical mixers may be formed between the neighboring light sources, and they may be placed between the light sources formed along a row and spaced apart from two light sources neighboring the optical mixer along the row by the same distance.

A diffusion plate may be formed over the light sources and the optical mixers, and the bottom surface of the diffusion plate may be spaced apart from the top surface of the optical mixers by a predetermined distance. A reflective sheet may be formed under the light sources and the optical mixers.

### BRIEF DESCRIPTION OF THE DRAWINGS

The present invention will become more apparent by describing embodiments thereof in detail with reference to the accompanying drawings, in which:

FIG. 1 is an exploded perspective view of an exemplary embodiment of an LCD with a backlight unit according to the present invention;

FIG. 2 is an exploded perspective view of an exemplary embodiment of a backlight unit according to the present invention;

FIG. 3 illustrates the positional relationship of light sources to optical mixers with the backlight unit shown in FIG. 2;

FIG. 4 is an exploded perspective view of another exemplary embodiment of a backlight unit according to the present invention;

FIG. 5 illustrates the positional relationship of light sources to optical mixers with the backlight unit shown in FIG. 4;

FIG. 6 is an exploded perspective view of another exemplary embodiment of a backlight unit according to the present invention;

FIG. 7 illustrates the positional relationship of light sources to optical mixers with the backlight unit shown in FIG. 6; and

FIG. 8 is a sectional view of an exemplary embodiment of a backlight unit according to the present invention.

### DETAILED DESCRIPTION OF THE INVENTION

The present invention will be described more fully hereinafter with reference to the accompanying drawings, in which preferred embodiments of the invention are shown. The present invention may, however, be embodied in many different forms and should not be, construed as limited to the embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” other elements or features would then be oriented “above” the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

An exemplary embodiment of a backlight unit and an LCD according to the present invention will now be explained in detail.

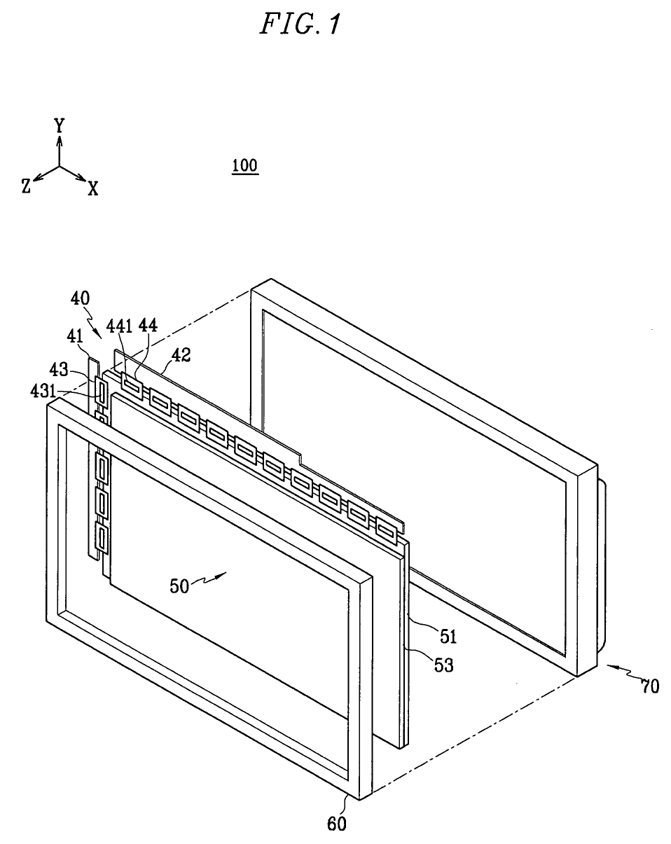

FIG. 1 is an exploded perspective view of an exemplary embodiment of an LCD with a backlight unit according to the present invention. The LCD 100 has a liquid crystal panel 50, and a backlight unit 70 combined with the liquid crystal panel 50.

The liquid crystal panel 50 is illustrated in FIG. 1 as an example of a flat panel display, but this is only to exemplify the present invention, which is not limited thereto. That is, other light-receiving types of flat panel displays may be used.

In the exemplary embodiment as illustrated in FIG. 1, the LCD 100 may be substantially frame shaped. For orientation purposes, a Cartesian coordinate system may be used where a first side of the display device extends along a Y-axis direction, and a second side of the display device extends along an X-axis direction, where the Y-axis is substantially perpendicular to the X-axis and a Z-axis direction is substantially perpendicular to both the X and Y axes.

An exemplary embodiment of the LCD according to the present invention includes the backlight unit 70, the liquid crystal panel 50 placed over the backlight unit 70, and a top chassis 60 surrounding the periphery of the liquid crystal panel 50 and fitted to the backlight unit 70.

A liquid crystal panel assembly 40 includes the liquid crystal panel 50, driver integrated circuit (IC) packages 43 and 44 connected to the liquid crystal panel 50 to supply driving signals thereto, and printed circuit boards 41 and 42. Chip on films (COFs) or tape carrier packages (TCPs) may be used to form the driver IC packages 43 and 44. The printed circuit boards 41 and 42 may be provided at the lateral side of the top chassis 60.

The liquid crystal panel 50 includes a TFT array panel 51 with a plurality of thin film transistors (TFTs) (not shown), a color filter array panel 53 placed over the TFT array panel 51, and liquid crystal (not shown) injected between the panels. Polarizers (not shown) may be attached to a top surface of the color filter array panel 53 and a bottom surface of the TFT array panel 51 to polarize the light passing through the liquid crystal panel 50.

The TFT array panel 51 may be based on a transparent glass substrate, on which the TFTs as switching elements and pixel electrodes (not shown) connected to the TFTs are arranged in a matrix form. The TFT has a gate terminal as a control terminal, an input terminal as a source terminal, a drain terminal as an output terminal, and a channel formation semiconductor. The source terminal is connected to a data line to receive image signals, and the gate terminal is connected to a gate line crossing the data line to receive scanning signals. The pixel electrode may be formed with a transparent conductive material based on indium tin oxide (ITO), and is connected to the drain terminal.

When electrical signals from the printed circuit boards 41 and 42 are input to the gate and data lines of the liquid crystal panel 50, electrical signals are input to the gate and source terminals of the TFTs, and the TFTs turn on or off in accordance with the input electrical signals to output electrical signals required for the pixel formation.

Meanwhile, the color filter array panel 53 faces the TFT array panel 51 with a predetermined distance therebetween. In exemplary embodiments, the color filter array panel 53 may be based on a substrate on which color pixels (not shown) for passing light and expressing colors are formed. The color pixels may include red, green, and blue (RGB) color pixels. The color pixels may be formed through a thin film formation process. An ITO-based common electrode (not shown) may be formed on the entire surface of the substrate. When the gate and source terminals of the TFTs are powered to turn on the TFTs, electrical fields are formed between the pixel electrodes and the common electrode of the color filter array panel. The liquid crystal injected between the TFT array panel 51 and the color filter array panel 53 is reoriented, and the light transmittance is varied in accordance with the reorientation of the liquid crystal, thereby obtaining desired images.

The printed circuit boards 41 and 42 receive the image signals from outside of the liquid crystal panel 50, and apply driving signals to the gate and the data lines, respectively. The printed circuit boards 41 and 42 are connected to the respective driver IC packages 43 and 44 attached to the liquid crystal panel 50. In order to drive the LCD 100, the gate-side printed circuit board 41 generates gate driving signals, and the data-side printed circuit board 42 generates data driving signals. The gate and data driving signals are generated together with a plurality of driving signals for timely transmitting the gate and data driving signals. The gate and data driving signals are applied to the gate and the data lines of the liquid crystal panel 50 through the respective driver IC packages 43 and 44 with IC chips 431 and 441 mounted thereon. A control board (not shown) may be mounted on the rear side of the backlight unit 70. The control board is connected to the data-side printed circuit board 42 to convert analog data signals into digital data signals, and supplying them to the liquid crystal panel 50.

The top chassis 60 is provided on the liquid crystal panel assembly 40 to essentially bend the driver IC packages 43 and 44 along the lateral side of the backlight unit 70 and prevent the liquid crystal panel assembly 40 from being released from the backlight unit 70. In exemplary embodiments, a front case (not shown) and a rear case (not shown) are provided at the front of the top chassis 60 and at the rear of a bottom chassis 75, and are combined with each other to thereby form the LCD 100.

The backlight unit 70 will now be explained in further detail.

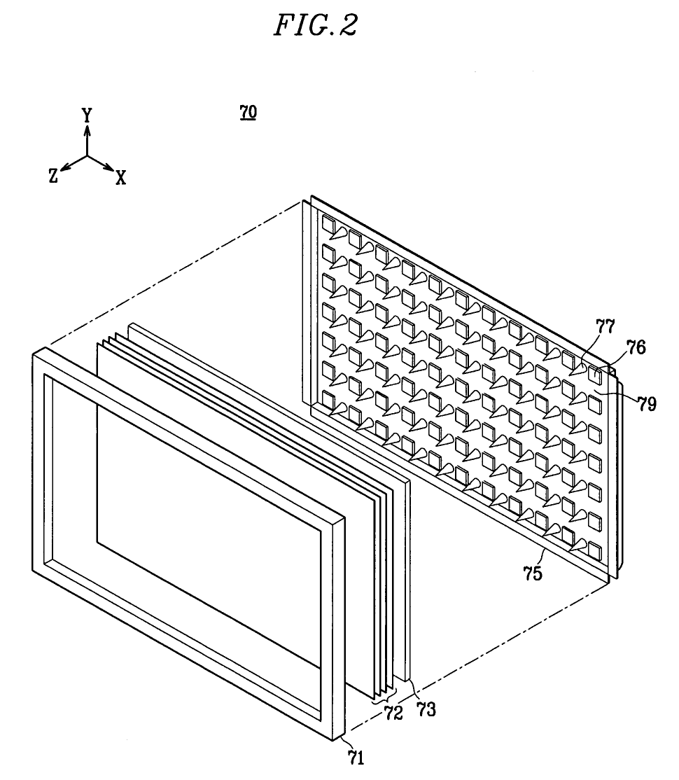

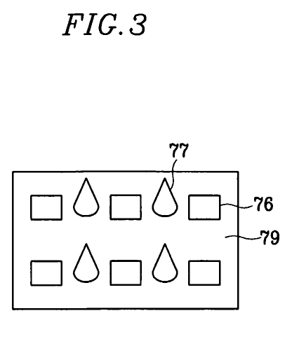

FIG. 2 is an exploded perspective view of an exemplary embodiment of a backlight unit 70 according to the present invention, and FIG. 3 illustrates the positional relationship of light sources 76 to optical mixers 77 of the backlight unit 70 shown in FIG. 2.

FIG. 2 is an exploded perspective view of an exemplary embodiment of a backlight unit 70 according to the present invention, which is a direct type that is mainly used for a large TV.

The structure of the backlight unit 70 shown in FIG. 2 is only to exemplify the present invention, which is not limited thereto. The present invention may be applied to other structured backlight units.

The backlight unit 70 includes optical sheets 72, a diffusion plate 73, light sources 76, optical mixers 77, and a reflective sheet 79, which are assembled with each other. With the backlight unit 70, the light from the light sources 76 may be uniformly diffused and emitted in the direction of the Z axis. The bottom chassis 75 placed at the bottom of the backlight unit 70 receives the internal components of the backlight unit 70, and fixes them with a mold frame 71. The light sources 76 are fitted to or disposed on a surface of the bottom chassis 75, that is, the inner surface thereof.

FIG. 2 illustrates a light emitting diode (LED) as the light source 76. The LED shown in FIG. 2 as the light source 76 is only to exemplify the present invention, which is not limited thereto. In addition to the LED, a lamp may be used as the light source 76.

The light sources 76 shown in FIG. 2 may include color LEDs. The color LEDS may include red (R), green (G), and blue (B) LEDs. The red (R), green (G), and blue (B) LEDs may be sequentially arranged to illuminate a white light with a uniform sum thereof, or the respective LEDs may illuminate white light themselves. In a preferred exemplary embodiment, the light sources 76 include red (R), green (G), and blue (B) components to illuminate the white light. While the light sources 76 are represented in a substantially rectilinear shape, the light sources 76 may be of any shape that is capable of effectively illuminate the light, such as a cylinder or a spherical shape.

The light sources 76 are mounted on a substrate overlaid with a reflective sheet 79. The light sources 76 are connected to an inverter (not shown) which is a power supply PCB to receive the driving voltages therefrom.

Optical mixers 77 are formed between the light sources 76. As illustrated in FIG. 2, each optical mixer 77 is cone-shaped with a height greater than the light source 76 in a direction substantially perpendicular to the bottom chassis 75, that is, in the Z direction. The optical mixer 77 may be formed including a highly reflective material, and preferably with a material that reflects all of the light incident thereto. In another alternative exemplary embodiment, a reflective material may be coated on only the outer surface of the optical mixer 77. The optical mixer 77 may be formed with any shape that is capable of effectively diffusing the light, such as a cylinder, a tetrahedron, a triangular prism, a pyramid, a cube, a polyhedron, a polygonal prism and any combination including at least one of the foregoing. Most of the light emitted from the light source 76 is projected toward the diffusion plate 73 and is partially reflected against the reflective sheet 79, and is then incident to the overlying diffusion plate 73. A part of the emitted light is reflected against the optical mixers 77, and is also incident to the diffusion plate 73.

The light emitted from the light sources 76 passes through the above-identified routes with a uniform light distribution. The light is further uniformly distributed while passing through the diffusion plate 73, and is enhanced in brightness while passing through the optical sheets 72 placed over the diffusion plate 73 to be thereby transmitted in the Z-axis direction. Advantageously, light that is uniformly distributed and enhanced in brightness can be illuminated.

The optical sheets 72 are formed by sequentially placing two or more optical films on the diffusion plate 73. A diffusion film, a brightness enhancement film (BEF), and a dual brightness enhancement film (DBEF) may be used to form the optical sheets 72.

FIG. 3 illustrates the positional relationship of the light sources 76 to the optical mixers 77 of the backlight unit 70 shown in FIG. 2 in detail. A plurality of light sources 76 are aligned with each other substantially in rows and columns, in the X and Y directions, respectively. The optical mixers 77 are individually arranged between the light sources 76 along the rows. In a preferred exemplary embodiment, the optical mixers 77 are spaced apart from the light sources 76 neighboring or adjacent thereto by a predetermined distance. As shown in FIG. 3, each optical mixer 77 is formed between the light sources 76 neighboring each other along the row. In alternative exemplary embodiments, an optical mixer 77 may be formed between the light sources 76 neighboring each other along a column, or along a row and a column. While the light sources 76 and optical mixers 77 are illustrated in a row-column arrangement, any of a number of configurations may be used as is suitable for the purposes described herein, such as in a diagonal or lattice-type formation.

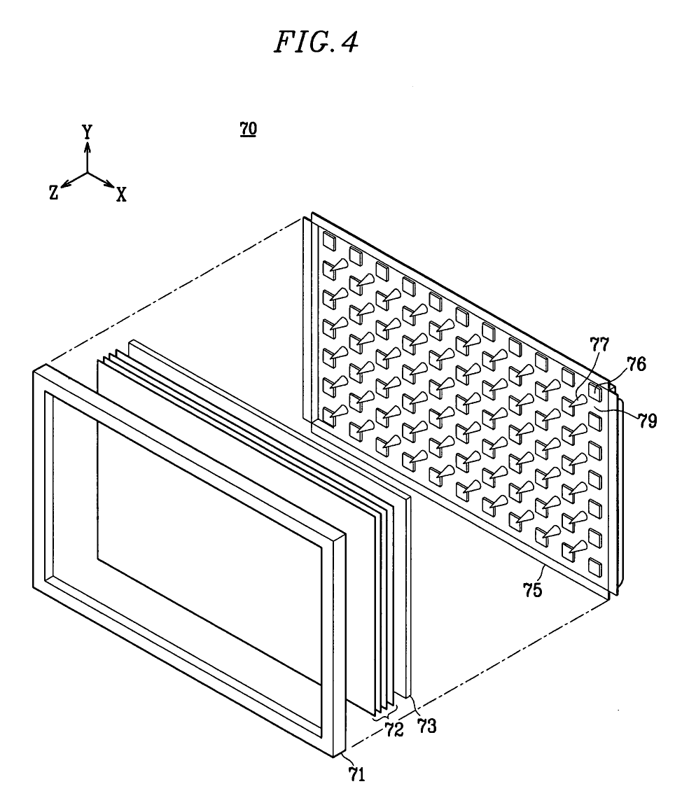

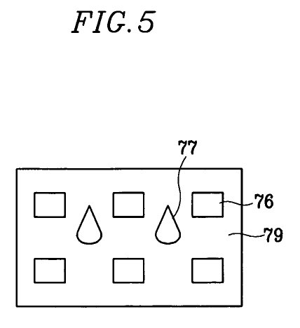

Another exemplary embodiment of a backlight unit according to the present invention will now be explained with reference to FIGS. 4 and 5.

FIG. 4 is an exploded perspective view of another exemplary embodiment of a backlight unit 70 according to the present invention, and FIG. 5 illustrates the positional relationship of light sources 76 to optical mixers 77 with the backlight unit 70 shown in FIG. 3.

With the backlight unit 70 shown in FIGS. 4 and 5, the positional relationship between the light sources 76 and the optical mixers 77 differs from that of the backlight unit shown in FIGS. 2 and 3.

As shown in FIG. 5, a plurality of light sources 76 are aligned with each other substantially in rows and columns and optical mixers 77 are individually formed between the light sources 76 neighboring each other in the diagonal direction. The optical mixers 77 are preferably spaced apart from the light sources 76 neighboring thereto by a predetermined distance. With the backlight unit shown in FIG. 5, the optical mixers 77 are located at the crossing points of the opposite diagonal lines of a rectangle with the light source 76 at the apexes thereof.

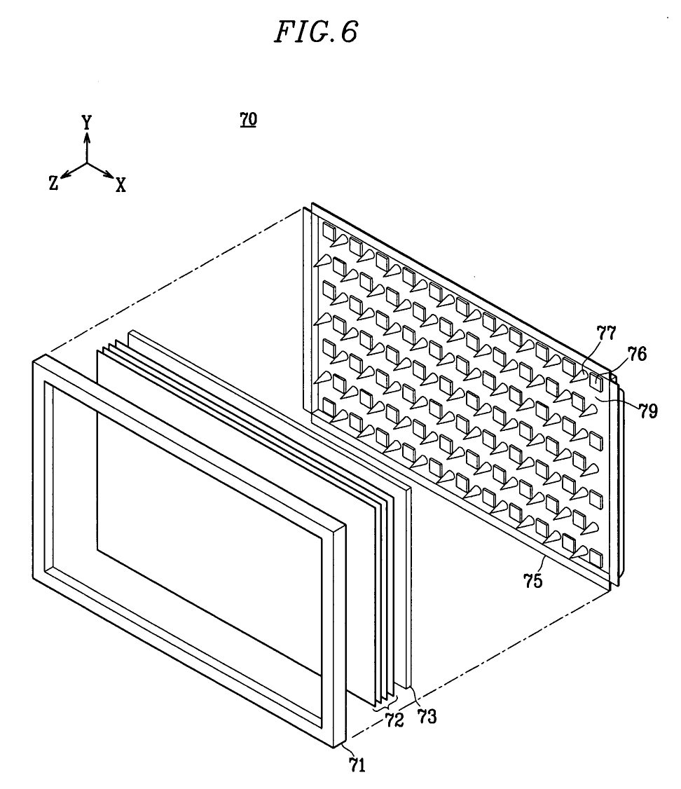

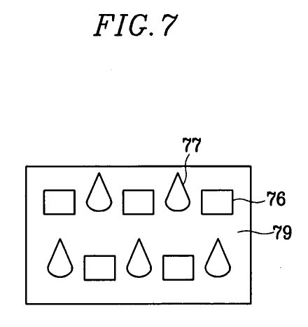

FIGS. 6 and 7 show light sources 76 and optical mixers 77 with a positional relationship that is different from that shown in FIGS. 2 to 5.

FIG. 6 is an exploded perspective view of another exemplary embodiment of a backlight unit 70 according to the present invention, and FIG. 7 illustrates the positional relationship of light sources 76 to optical mixers 77 with the backlight unit 70 shown in FIG. 6.

As shown in FIG. 7, a plurality of light sources 76 are spaced apart from each other by the same distance along rows, but are diverged in arrangement from each other along the columns. Two light sources 76 neighboring each other on one row and an adjacent light source 76 on the next row preferably form an isosceles triangle. Meanwhile, the optical mixers 77 are individually each between the light sources 76 neighboring each other along the rows. Each optical mixer 77 is preferably spaced apart from the light sources neighboring thereto by the same distance. The rows and columns shown in FIG. 7 may be switched with each other, such that the top row has the arrangement of the bottom row.

As described above, the light sources 76 and the optical mixers 77 may have various positional relationships other than those explained above. Furthermore, the number of light sources 76 and optical mixers 77 may be varied depending upon the size of the LCD and the locations thereof.

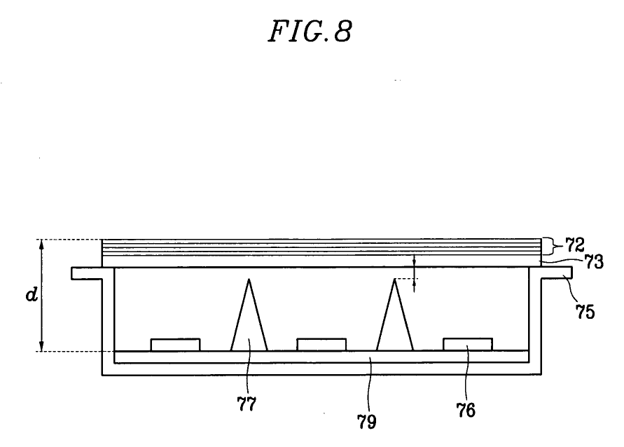

FIG. 8 is a sectional view of an exemplary embodiment of a backlight unit 70 according to the present invention.

The structure shown in FIG. 8 may be applied to the cases shown in FIGS. 2 to 7.

As shown in FIG. 8, a reflective sheet 79 is formed at the bottom of the bottom chassis 75 on an inner face thereof. In an alternative exemplary embodiment, a reflective sheet or a reflective material may be formed at the inner surface of lateral sides of the bottom chassis 75. Light sources 76 are formed on the reflective sheet 79 such that the light sources 76 are arranged with a predetermined distance therebetween. Optical mixers 77 are individually formed between the light sources 76 such that they are spaced apart from the light sources 76 by a predetermined distance. In preferred exemplary embodiments, the optical mixers 77 are greater in height than the light sources 76 in a direction substantially perpendicular to the reflective sheet 70. A diffusion plate 73 and a plurality of optical sheets 72 are formed over the bottom chassis 75.

The diffusion plate 73 and the optical mixers 77 are preferably spaced apart from each other by a predetermined distance as indicated by the arrows proximate an apex or highest point of the optical mixers 77. If the optical mixers 77 contact or are disposed too close to the diffusion plate 73, ring-shaped bright lines may be perceived.

In other exemplary embodiments, supports (not shown) may be formed between the light sources 76 and the optical mixers 77 to support the diffusion plate 73 and the optical sheets 72. The number of supports is preferably minimized to three to five. The supports contact the bottom surface of the diffusion plate 73 to support the diffusion plate 73 and the optical sheets 72. As the number of supports is relatively small, the ring-shaped bright lines are not perceived from the outside.

When the height between the top surface of the reflective sheet 79 and the top surface of the optical sheet 72 is indicated by “d”, as the value of “d” is reduced, the thickness of the backlight unit 70 and the overall thickness of the LCD 100 is reduced. Advantageously, as the light emitted from the light sources 76 is reflected against the optical mixers 77 and mixed once more, the brightness distribution over the optical sheets 72 is uniform even when the value of “d” is reduced.

In one exemplary embodiment, the height of the cones of the optical mixers 77 may range from about 5 mm to about 18 mm. A diameter of a base of the cone-shaped optical mixers 77 may range from about 5 mm to about 8 mm. In a preferred exemplary embodiment, when the height “d” between the top surface of the reflective sheet 79 and the top surface of the topmost optical sheet 72 has a value of about 20 mm, the brightness is uniformly distributed.

In an exemplary embodiment, optical mixers are individually formed between the light sources such that the light emitted from the light sources becomes uniform while passing through the optical mixers. Advantageously, even when the thickness of the backlight unit is reduced, the brightness distribution of the light is uniform.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A backlight unit comprising:
light sources; and
optical mixers individually formed between the light sources.

2. The backlight unit of claim 1, wherein the optical mixers comprise a reflective material.

3. The backlight unit of claim 1, wherein the optical mixers are shaped as cones.

4. The backlight unit of claim 1, wherein the optical mixers have a height greater than a height of the light sources.

5. The backlight unit of claim 1, wherein the light sources are aligned with each other in columns and rows.

6. The backlight unit of claim 5, wherein individual optical mixers are formed between light sources neighboring each other.

7. The backlight unit of claim 6, wherein the optical mixers are formed along the columns or the rows.

8. The backlight unit of claim 6, wherein the individual optical mixers are formed between the light sources neighboring each other in a diagonal direction.

9. The backlight unit of claim 6, wherein the optical mixers are spaced apart from the light sources neighboring the optical mixers by a same distance.

10. The backlight unit of claim 1, wherein light sources are arranged along a row such that they are spaced apart from each other by a predetermined distance, and the light sources in the row are diverged in arrangement from light sources at adjacent rows.

11. The backlight unit of claim 10, wherein individual optical mixers are formed between light sources neighboring each other.

12. The backlight unit of claim 11, wherein the individual optical mixers are placed between the light sources formed along a row, and are spaced apart from two light sources neighboring the optical mixer along the row by the same distance.

13. The backlight unit of claim 1, wherein a diffusion plate is formed over the light sources and the optical mixers.

14. The backlight unit of claim 13, wherein a plurality of optical sheets are formed over the diffusion plate.

15. The backlight unit of claim 13, wherein a bottom surface of the diffusion plate is spaced apart from a top surface of the optical mixers by a predetermined distance.

16. The backlight unit of claim 1, wherein a reflective sheet is formed under the light sources and the optical mixers.

17. A liquid crystal display comprising:
a display panel; and
a backlight unit placed under the display panel and including light sources and optical mixers;
wherein the optical mixers are individually formed between the light sources, and the light sources emit light toward the display panel.

18. The liquid crystal display of claim 17, wherein the optical mixers have a height greater than a height of the light sources.

19. The liquid crystal display of claim 17, wherein the light sources are aligned with each other in columns and rows.

20. The liquid crystal display of claim 19, wherein the optical mixers are formed between light sources neighboring to each other.

21. The liquid crystal display of claim 20, wherein the optical mixers are formed along the columns or the rows.

22. The liquid crystal display of claim 20, wherein individual optical mixers are formed between the light sources neighboring each other in a diagonal direction.

23. The liquid crystal display of claim 20, wherein the optical mixers are spaced apart from the light sources neighboring thereto by a same distance.

24. The liquid crystal display of claim 17, wherein light sources are arranged along a row such that the light sources are spaced apart from each other by a predetermined distance, and are diverged in arrangement from light sources at adjacent rows.

25. The liquid crystal display of claim 24, wherein the optical mixers are individually formed between light sources neighboring each other.

26. The liquid crystal display of claim 25, wherein the optical mixers are individually placed between the light sources formed along a row, and are spaced apart from two light sources neighboring the optical mixer along the row by a same distance.

27. The liquid crystal display of claim 17, wherein a diffusion plate is formed over the light sources and the optical mixers, and a bottom surface of the diffusion plate is spaced apart from a top surface of the optical mixers by a predetermined distance.

28. The liquid crystal display of claim 17, wherein a reflective sheet is formed under the light sources and the optical mixers.
